(19) United States
(12) Patent Application Publication
(10) Pub. No.: US 2026/0359428 A1
(43) Pub. Date: Nov. 12, 2026

(54) CONTEXT-SENSITIVE SECURITY SYSTEM FOR ARTIFICIAL INTELLIGENCE APPLICATIONS

(71) Applicant: Palo Alto Networks, Inc., Santa Clara, CA (US)

(72) Inventors: Chien-Hua Lu, San Jose, CA (US); Yu Fu, Sunnyvale, CA (US); Jay Chien An Chen, Fairfax, VA (US); Nicole Nichols, Santa Clara, CA (US); Bo Qu, Saratoga, CA (US); Mei Wang, Saratoga, CA (US); Sahil Mehta, San Ramon, CA (US); Jaimin Pankajkumar Patel, San Jose, CA (US); Sergey Sviridov, Santa Clara, CA (US)

(21) Appl. No.: 19/041,416

(22) Filed: Jan. 30, 2025

(51) Int. Cl. G06F 21/55

(52) U.S. Cl. CPC G06F 21/554; G06F 2221/034

(57) ABSTRACT

An AI security system to protect AI applications against attacks, including first impression jailbreaking techniques, has been created. The AI security system employs a foundation model to protect AI applications by limiting valid intents of queries according to information about the AI application and checking topic integrity of each response in a conversation in view of conversation history and the response itself. The AI security system determines a set of intent validation rules based on information about the AI application and/or network traffic of the AI application. The intent validation rules allow for intent validation in the context or domain of the AI application. Assuming a query is deemed to have a valid intent and a response to the query is generated, the AI security system employs the foundation model to assess topic integrity of the response itself and topic integrity of the response with respect to conversation history.

### BACKGROUND

The disclosure generally relates to data processing (e.g., CPC subclass G06F) and to computing arrangements based on specific computational models (e.g., CPC subclass G06N).

Rapid developments in artificial intelligence (AI) technologies have spawned numerous terms with fluid meanings. Recently, AI technologies are frequently referred to with the terms large language model (LLM), generative AI or “genAI”, and foundation model. Many of these technologies are based on or relate to the “Transformer” architecture. A “Transformer” was introduced in VASWANI, et al. “Attention is all you need” presented in Proceedings of the 31st International Conference on Neural Information Processing Systems on December 2017, pages 6000-6010. The Transformer is a first sequence transduction model that relies on attention and eschews recurrent and convolutional layers. The Transformer architecture has been referred to as a “foundational model.” The Center for Research on Foundation Models at the Stanford Institute for Human-Centered Artificial Intelligence used this term in an article “On the Opportunities and Risks of Foundation Models” to describe a model trained on broad data at scale that is adaptable to a wide range of downstream tasks. There has been subsequent research in similar Transformer-based sequence modeling. The architecture of a Transformer model typically is a neural network with transformer blocks/layers, which include self-attention layers, feed-forward layers, and normalization layers. The Transformer model learns context and meaning by tracking relationships in sequential data. Some LLMs are based on the Transformer architecture. An LLM is “large” because the training parameters are typically in the billions and have been approaching a trillion parameters. AI technologies are not limited to LLMs and research and utilization of “lightweight” language models (i.e., fewer parameters than large) has grown. Language models can be pre-trained to perform general-purpose tasks or tailored to perform specific tasks.

Some LLMs are based on the Transformer architecture. An LLM is “large” because the training parameters are typically in the billions and trillions. AI technologies are not limited to LLMs and research and utilization of “lightweight” language models (i.e., fewer parameters than large) has grown. Language models can be pre-trained to perform general-purpose tasks or tailored to perform specific tasks. Tailoring of language models can be achieved through various techniques, such as prompt engineering and fine-tuning.

The growth in adoption of generative AI has been accompanied by abuse and exploitation to attack applications that use generative AI. Malicious actors have been maliciously manipulating prompts (i.e., the input to a generative AI model). At this time, malicious prompt manipulation is also referred to as prompt hacking. Categories of existing prompt hacking are prompt injection (including direct and indirect prompt injection), prompt leaking, and jailbreaking. Although the terms prompt injection and prompt hijacking are often informally used to refer to any type of prompt manipulation that abuses a generative AI model or foundation model, the use is imprecise. Similar to a SQL injection attack, prompt injection attacks mix benign task instructions with malicious task instructions in a prompt. Prompt hacking that is a jailbreaking type of attack involves the crafting of a prompt or series of prompts to bypass guardrails that provide measures for controlling behaviors of language models. Jailbreaking a generative AI model can be single-turn or multi-turn. Successful attacks can lead to the leakage of sensitive information, unauthorized access to systems, or the generation of deceptive content.

### BRIEF DESCRIPTION OF THE DRAWINGS

Embodiments of the disclosure may be better understood by referencing the accompanying drawings.

FIG. 1 is a diagram of a context-sensitive AI security system analyzing a query and a response to an AI application to protect the AI application against an attack.

FIG. 2 is a diagram of a context-sensitive AI security system deployment with context-sensitive components per AI application and a context-agnostic component to support multiple AI applications.

FIG. 3 is a flowchart of example operations for analyzing queries to AI applications for an attack signal based on intent validity of queries.

FIG. 4 is a flowchart of example operations for analyzing responses from AI applications for cyberattack signals based on conversation topic integrity.

FIG. 5 depicts an example computer system with a context-sensitive AI security system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### INTRODUCTION

While content filters have been deployed to detect jailbreaking attacks on foundation models and guardrails installed to avoid undesired behavior (i.e., response content) from a foundation model, jailbreaking techniques continue increasing in sophistication and evade detection. For instance, data extraction attacks or RAG (Retrievel-Augmented Generation) document extraction attacks leverage knowledge of the embeddings models to craft a prompt(s) based on the statistical information gathered about the embeddings/vectors to increase the likelihood of collisions with embeddings of sensitive documents. When targeting an AI application, a malicious actor can use brute force techniques or social engineering attacks to identify the embedding model used for an AI application. With the embedding model determined, the malicious actor can gather the statistical information corresponding to distribution of embeddings.

### Overview

A context-sensitive security system to protect AI applications (and foundation models in general) against attacks, including first impression jailbreaking techniques, has been created. The context-sensitive system (“AI security system”) employs a foundation model to protect AI applications/foundation models by limiting valid intents of queries according to information about the AI application and checking topic integrity of each response in a conversation in view of conversation history and the response itself. The AI security system determines a set of intent validation rules based on information about the AI application and/or network traffic of the AI application. The intent validation rules allow for intent validation in the context or domain of the AI application. Assuming a query is deemed to have a valid intent and a response to the query is generated, the AI security system employs the foundation model to assess topic integrity of the response itself and topic integrity of the response with respect to conversation history. If the AI security system determines that a response fails the integrity check, then the response is blocked.

### Example Illustrations

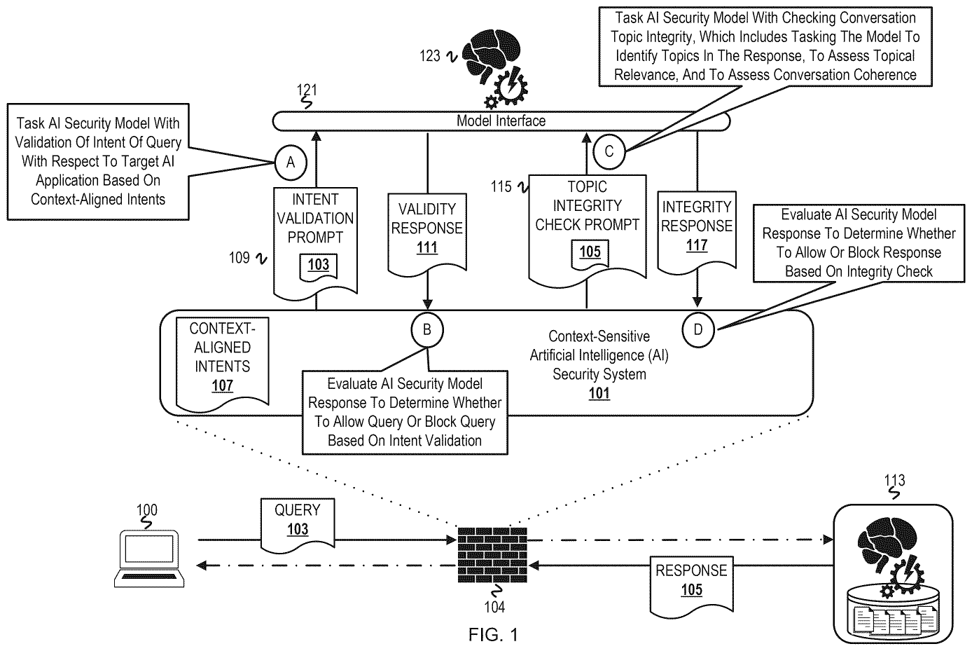

FIG. 1 is a diagram of a context-sensitive AI security system analyzing a query to and a response from an AI application to protect the AI application against an attack. A context-sensitive AI security system 101 is depicted as a service of a firewall 104. The firewall 104 may be a hardware firewall or a software firewall deployed at some point in-line with respect to users and an AI application 113. The context-sensitive AI security system 101 includes or communicates with a foundation model 123. The context-sensitive AI security system 101 prompts the foundation model 123 via a model interface 121, such as an application programming interface (API). The depicted AI application 113 is an application that uses a RAG-based large language model (LLM). In this illustration, a device 100 has communicated a query 103 to the AI application 113. The firewall 104 performs in-line analysis on the query 103. The context-sensitive AI security system 101 may run locally on the firewall 104 or may be a service exposed to the firewall 104 via an API.

FIG. 1 is annotated with a series of letters A-D representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the context-sensitive AI security system 101 tasks the foundation model 123 with validation of intent of the query 103. The description will refer to the foundation model 123 as the “AI security model” to distinguish from the model of the AI application 113. The context-sensitive AI security system 101 has access to context-aligned intents 107. The context-aligned intents 107 identify intents that have been determined as aligned with the context (also referred to as purpose, domain, or goal) of the AI application 113. In addition to the intents themselves, the file or object that indicates the context-aligned intents 107 can include descriptions of the context-aligned intents (also referred to herein as “valid intents”). The context-sensitive AI security system 101 constructs an intent validation prompt 109 that includes the context-aligned intents 107, the query 103, and a task instructing the AI security model 123 to determine an intent(s) of the query 103 and whether the determined intent(s) is valid with respect to the context-aligned intents 107.

At stage B, the context-sensitive AI security system 101 evaluates a validity response 111 from the AI security model 123. The AI security model 123 returns the validity response 111 in response to the intent validation prompt 109. The context-sensitive AI security system 101 determines whether to block or allow the query 103 based on whether the validity response 111 indicates that the intent(s) of the query 103 is valid. The remaining stages presume that the query 103 was determined to have valid intent. Accordingly, the AI application 113 returns a response 105 that the firewall 104 evaluates.

At stage C, the context-sensitive AI security system 101 tasks the AI security model 123 with checking conversation topic integrity after the firewall 104 detects the response 105 from the AI application 113. Tasking the AI security model 123 with checking conversation topic integrity includes tasking the AI security model 123 with identifying topics in the response 105, assessing relevance of the identified topics with respect to conversation history and AI application context, and assessing coherence of the conversation in light of the topics of the response 105. The context-sensitive AI security system 101 constructs a topic integrity check prompt 115 that includes instructions corresponding to the tasks, conversation history, and the response 105.

At stage D, the context-sensitive AI security system 101 evaluates an integrity response 117 from the AI security model 123 received in response to the topic integrity check prompt 115. The context-sensitive AI security system 101 determines whether the integrity response 117 indicates the integrity check has been passed or failed. For instance, the topic integrity check prompt 115 may have been constructed to include a task instruction to score integrity and coherence of the response. The context-sensitive AI security system 101 can determine whether the integrity check has been passed or failed by evaluating the scores against thresholds defined to represent sufficient topic integrity of the response. The context-sensitive AI security system 101 will indicate to the firewall 104 whether to allow or block the response 105 based on the evaluation of the integrity response 117.

Deployment of components of the context-sensitive AI security system or AI security system can vary while still providing protection. FIG. 1 illustrates a single exchange between the device 100 and the AI application 113 via the firewall 104. As already noted, the context-sensitive AI security system 101 may be a local service or cloud-based service. Furthermore, the context-sensitive AI security system 101 may be deployed to support numerous security appliances across multiple enterprises.

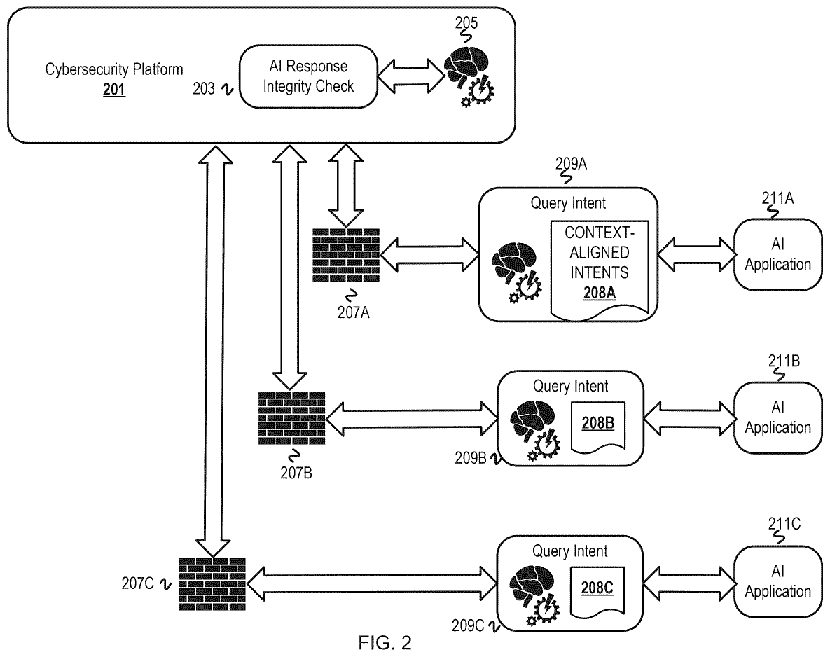

FIG. 2 is a diagram of a context-sensitive AI security system deployment with context-sensitive components per AI application and a context-agnostic component to support multiple AI applications. FIG. 2 depicts AI applications 211-211C. These AI applications 211A-211C can be for one or more enterprises. Regardless of the AI application ownership, the AI applications 211A-211C are protected by a cybersecurity platform 201. While the cybersecurity platform 201 likely offers other services, FIG. 2 focuses on the service or context-sensitive AI security system offered by the cybersecurity platform 201 to protect the AI applications 211A-211C. Context-aligned intents 208A-208C have been determined for the AI applications 211A-211C, respectively. These context-aligned intents 208A-208C have been deployed with query intent components 209A-209C. Each of these query intent components 209A-209C has been deployed with a foundation model (e.g., a lightweight model) or access to a foundation model that has been primed or tuned with the corresponding one of the context-aligned intents 208A-208C. When determining validity of query intent, a query intent component can prompt its corresponding foundation model with the query alone, although the task instructions may be reiterated based on queries evaluated. In contrast, responses from the AI applications 211A-211C can be checked for topic integrity and conversation coherence with a foundation model 205 that is not tuned to an application context but will instead have conversation history to provide context. FIG. 2 depicts security appliances 207A-207C corresponding to traffic flows with the AI applications 211A-211C, respectively. However, this is depicted to provide a simple illustration and not necessary. Many security and network deployments are possible and allow for a security appliance to have visibility of traffic from multiple AI applications. Regardless, the security appliances 207A-207C interact with the cybersecurity platform 201 (and may be considered part of the platform 201) when a response from an AI application is detected. As AI application responses are involved, calls from the security appliances 207A-207C are directed to a component 203 that is the AI response integrity check component of the context-sensitive AI security system offered by the platform 201. The component 203 will interact with the foundation model 205 to check integrity of responses based on the topics identified within the responses and conversation history.

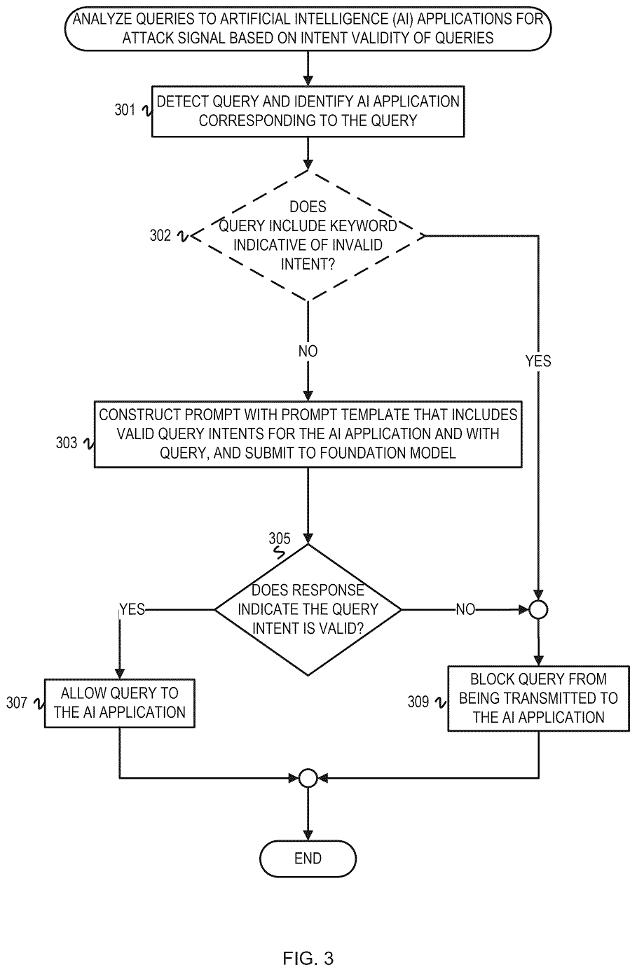

FIG. 3 is a flowchart of example operations for analyzing queries to AI applications for an attack signal based on intent validity of queries. Misalignment of intent of a query with intents deemed valid based on context of a targeted AI application is treated as an attack signal. Valid query intents for an AI application can be determined from information about the AI application and can be collected from an owner/administrator of an AI application. In addition, valid query intents can be determined from analyzing safe/benign traffic of an AI application. Benign queries can be analyzed to extract intents of those queries. The example operations presume that the AI security system is protecting multiple AI applications.

At block 301, the AI security system detects a query and identifies an AI application corresponding to the query. For instance, a security appliance performing in-line inspection of network traffic may detect a query in a network traffic flow of an AI application. The security appliance may then submit a request to the AI security system that indicates the query and an identifier of the AI application. In another implementation, the AI security system has visibility of incoming queries at an application layer prior to receipt by the AI application. In this case, identity of the AI application is known by the AI security system based on configuration information, for example.

At block 302, the AI security system determines whether the query includes a keyword indicative of an intent that is invalid for the AI application. This is an optional determination. If performed, the AI security system would have access to a list of keywords that have been determined as indicative of invalid intent for the AI application. The AI application security would search the query for the keywords. If any of the keywords are found in the query, then operational flow proceeds to block 309 to block the query. Otherwise, operational flow proceeds to block 303.

At block 303, the AI security system constructs a prompt for query intent validation. The AI security system uses a prompt template with task instructions for a foundation model to determine intent(s) in a query and determine whether each determined intent aligns with valid intents. The AI security system will have access to a set of valid intents maintained to align with the AI application. The set of valid intents can be maintained as structured data, for example a JavaScript® Object Notation (JSON) file, that identifies each valid intent, describes each valid intent, and provides one or more examples corresponding to each valid intent. The AI security system can populate the prompt with the valid intents and the query. After constructing the prompt, the AI security system submits the query intent validation prompt to the foundation model. Below is a generic example of a prompt template followed by specific “bot” examples for query intent validation in an example structured format.

### Generic Example Prompt Template

[
{“Target Task Scope” : “Target AI agent is a professional medical assistant with
responsibilities including <define responsibilities and constraints of AI application>. The
AI agent can only respond to user queries based on the following intents: <Intent1> and
<Intent2>. Please ensure queries are coherent, concise, and directly aligned with the
query intent. If a query is vague or unclear, then indicate that the query has invalid intent
for the AI agent.” }
{″intent″: ″Intent1″,
″description″: ″Queries related to <descriptors corresponding to Intent1>.″,
″examples″: [
<Example queries that align with Intent1.>
]},
}
{″intent″: ″Intent2″,
″description″: ″Queries related to <descriptors corresponding to Intent2>.″,
″examples″: [
<Example queries that align with Intent2.>
]},
}]

### Example Medical Bot Prompt Template

[
{“Target Bot Task Scope” : “Target Bot is a professional medical assistant bot designed
to provide accurate information, schedule appointments, and offer guidance on
medication use. It can only respond to user queries based on the following valid intents:
Provide Medical Information, Assist with Appointment Scheduling, and Provide
Medication Guidance. Please ensure queries are coherent, concise, and directly aligned
with one of the valid query intents. Reject for vague or unclear queries.” }
{″intent″: ″Provide Medical Information″,
″description″: ″Queries related to general medical knowledge, symptoms, or conditions.″,
″examples″: [
″What are the symptoms of diabetes?″,
″Can you explain how high blood pressure affects the heart?″,
″What are the side effects of ibuprofen?″
]},
{″intent″: ″Assist with Appointment Scheduling″,
″description″: ″Queries related to booking, rescheduling, or canceling appointments with
medical professionals.″,
″examples″: [
″I want to book an appointment with a dermatologist.″,
″Can you reschedule my check-up to next Friday?″,
″Cancel my session for tomorrow.″
]},
{″intent″: ″Provide Medication Guidance″,
″description″: ″Queries related to proper medication usage, dosages, and interactions.″,
″examples″: [
″How often should I take amoxicillin?″,
″Can I take aspirin with blood thinners?″,
″What should I do if I miss a dose of my medication?″
]}
]

### Information Technology Helpdesk Bot Prompt Template

[
{ “Target Bot Task Scope″: “Target Bot is a professional IT helpdesk assistant designed
to provide technical support for diagnosing and resolving software and hardware issues,
as well as troubleshooting business productivity applications. It can only respond to user
queries based on the following valid query intents: Troubleshoot Software Issues,
Hardware Support, and Troubleshoot Business Productivity Applications. Please ensure
responses are coherent, concise, and directly aligned with one of the valid query intents.
Reject vague or unclear queries.” },
{″intent″: ″Troubleshoot Software Issues″,
″description″: ″Queries related to diagnosing and resolving software-related problems.″,
″examples″: [
″Why is my email not syncing with the e-mail system?″,
″I can't access the company VPN. Can you help?″,
″How do I fix a ′file not found′ error in the word processing application?″
]},
{″intent″: ″Hardware Support″,
″description″: ″Queries related to resolving hardware issues or checking hardware
status.″,
″examples″: [
″My laptop is overheating. What should I do?″,
″How can I connect an external monitor?″,
″The printer isn't working. Can you help me troubleshoot?″
]},
{″intent″: ″Troubleshoot Business Productivity Applications″,
″description″: ″Queries related to diagnosing and resolving issues with Business
Productivity Applications, such as applications for work processing, spreadsheet, or e-
mail”,
″examples″: [
″Why is my e-mail application not syncing emails?″,
″The spreadsheet application keeps crashing when I open large files. What should I do?″,
″The meeting application will not let me join meetings. Can you fix this?″
]},
]

At block 305, the AI security system determines whether the response to the query intent validation prompt indicates that the intent(s) of the query is valid. The response from the foundation model can include a yes or no answer for whether every intent of the query was valid for the AI application. If a query has multiple detected intents and only one does not align with the AI application (i.e., is not valid), then the foundation model will answer that the query is invalid. If the response indicates that the query is valid, then operational flow proceeds to block 307. Otherwise, operational flow proceeds to block 309.

At block 307, the AI security system allows the query to the AI application. For example, the AI security system notifies a security appliance performing in-line inspection that the query can proceed to the AI application. As another example, the AI security system itself allows the query to continue to the AI application.

At block 309, the AI security system blocks the query from being transmitted to the AI application. Again, the AI security system can notify a security appliance to not transmit or block transmission of the query. The AI security system can capture the query and corresponding network traffic for further forensic analysis or to learn any new technique being utilized for model attacks.

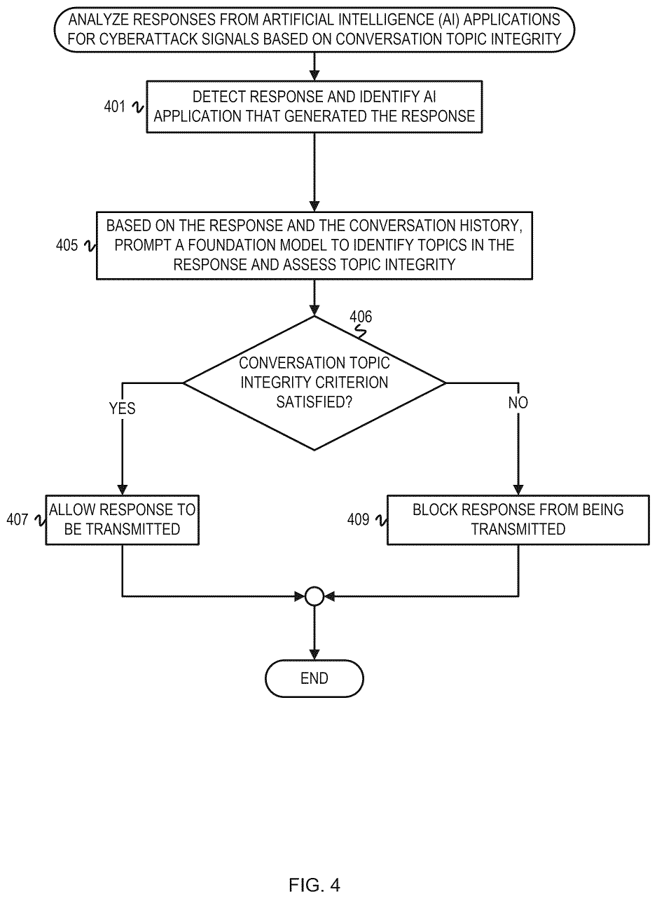

FIG. 4 is a flowchart of example operations for analyzing responses from AI applications for cyberattack signals based on conversation topic integrity. Failure of a topic integrity check of a response is a signal of data exfiltration. A topic integrity check can be based on a response alone or can be based on the response and conversation history. Quantity of topics within a response can alone be indicative of data exfiltration. With topics of a response and conversation history, relevance and coherence can also be assessed.

At block 401, the AI security system detects a response and identifies an AI application that generated the response. As with query detection, response detection can be in-line either by the AI security system itself (e.g., a component within or directly in communication with the AI application) or by a security appliance that communicates with the AI security system. Likewise, identification of the AI application that generated the response can be based on previous identification from network traffic analysis (e.g., application identifying technology often referred to as AppID). In other implementations, the AI security system can query an endpoint identified with a network address in the protocol data unit (PDU) carrying the response (e.g., header of a packet or application layer message).

At block 405, the AI security system prompts a foundation model to identify topics in the response and assess topic integrity based on the response and the conversation history. Since LLMs or generative AI applications maintain context within each conversation session by including all relevant conversation data within each response, the AI security system uses the available history in the response. The AI security system constructs a prompt with task instructions, for instance from a prompt template defined for topic integrity checking, that instruct a foundation model to identify topics in the response and assess integrity of the response based on topic metrics at both response level and conversation level (e.g., relevance, continuity, and/or coherence with respect to the conversation history). The AI security system also inserts the response and the conversation history into the prompt. The task instructions can include instructions to provide a response with data that is further evaluated by the AI security system for the integrity check, such as conversation level metrics related to coherence or continuity. For example, the task instructions can instruct the foundation model to generate a score for each topic for each aspect of integrity check and analyze the scores. As another example, the task instructions can instruct the foundation model to perform the assessment and provide an answer of yes or no with respect to whether the response satisfies the integrity check. Below is an example prompt template for tasking a foundation model with assessing different aspects of topic-based integrity for a response.

{
“task_description”: “You are an expert in analyzing conversations for topical coherence
and continuity. Your task is to evaluate a conversation's flow by identifying the main
topics in the response and the conversation, assessing relevance of each topic of the
response with respect to the ongoing context, and detecting any unusual topic shifts in the
most recent response.”,
″input″: {
″conversation_history″: ″The entire conversation history, including the bot's latest
response.″
},
″analysis_requirements″: {
″identify_topics″: ″Extract and list the main topics discussed in the latest response.″,
″relevance_scoring″: ″For each topic, assign a relevance score (on a scale of 1 to 10)
indicating its alignment with the ongoing conversation context.″,
″coherence_scoring″: ″Assign an overall coherence score (on a scale of 1 to 10) for the
latest response, reflecting how well it maintains the conversational flow.″,
″flag_unusual_shifts″: ″Determine if the latest response contains an unusually high
number of unrelated topics. If so, flag it as ′unusual_topic_shift_flag: true′.″
},
″output_format″: {
″json_structure″: {
″topics_identified″: [
″Topic 1″,
″Topic 2″,
″Topic 3″
],
″relevance_scores″: {
″Topic 1″: 7,
″Topic 2″: 8,
″Topic 3″: 5
},
″overall_coherence_score″: 9,
″unusual_topic_shift_flag″: false
}
},
″guidelines″: {
″scoring_basis″: ″Base relevance and coherence scoring on logical connections between
the identified topics and the conversation context.″,
″flagging_criteria″: ″Only flag responses as ′unusual_topic_shift_flag: true′ if they clearly
introduce multiple unrelated topics without a natural conversational link.″
},}

At block 406, the AI security system determines whether a conversation topic integrity criterion or criteria are satisfied. The criterion or criteria will depend on the task given to the foundation model. As an example, criteria to pass the integrity check can be that every topic relevance score exceeds a minimum threshold and unusual shifts in topic are not detected. As another example, a criterion for passing the integrity check can be based on a coherence threshold defined as n topics and if a response has a quantity of topics that exceeds the threshold, then the response is deemed incoherent. If the conversation topic integrity criterion is satisfied, then operational flow proceeds to block 407. If the AI security system determines that the conversation topic integrity criterion is not satisfied, then operational flow proceeds to block 409.

At block 407, the AI security system allows the response to be transmitted. For example, the AI security system notifies a security appliance or network element that the response can be forwarded. As another example, the AI security system itself allows the response to be communicated from the AI application.

At block 409, the AI security system blocks the response from being transmitted. Again, the AI security system can notify a security appliance or network element block transmission of the response. The AI security system can capture the response and corresponding network traffic for further forensic analysis.

The example operations are described with reference to an AI security system for consistency with the and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

### Variations

The description refers to protection of RAG-based AI applications against data exfiltration, however embodiments are not so limited. The disclosed techniques for securing AI applications can be used to prevent transmission of malicious prompts/queries and prevent responses that can negatively impact reputation of the AI application or AI application owner, which includes data exfiltration.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, which employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

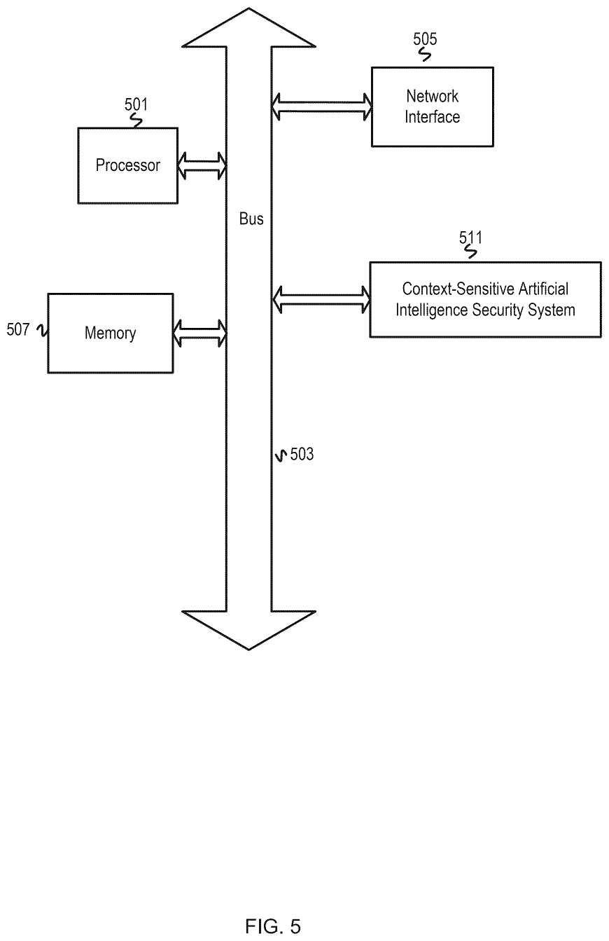

FIG. 5 depicts an example computer system with a context-sensitive AI security system. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes context-sensitive AI security system 511. The context-sensitive AI security system 511 learns context or domain of each AI application to be protected. Learning context can be obtaining information describing the scope, role, and/or responsibilities of an AI application; identifying the scope, role, and/or responsibilities of an AI application based on benign queries and responses of an AI application; and/or revising obtained or identified information. With the learned context, the context-sensitive AI security system 511 constrains queries to the learned context by using a foundation model to enforce alignment between intent identified in a query and query intents already determined to be valid for the AI application. The context-sensitive AI security system 511 then assesses responses from the AI application for topic-based integrity. The context-sensitive AI security system 511 uses the foundation model or another foundation model to identify main topics in a response and determine topic integrity based on any one or more of quantity of different topics, relevance of topics with respect to conversation history, coherence of the response with respect to the conversation, and continuity or shifts in the conversation. The context-sensitive AI security system 511 can initiate a security action(s) based on the determinations of intent validity of queries and integrity of responses. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### TERMINOLOGY

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
prompting a first large language model (LLM) to evaluate a first query against a query intent validation rule, wherein prompting the first LLM comprises prompting the first LLM with the first query and the query intent validation rule which comprises a set of one or more valid intents corresponding to a set of one or more knowledge bases, wherein the first query is to a retrieval augmented generation (RAG) based LLM or application that uses the RAG based LLM;
rejecting the first query based on a response from the first LLM indicating that the first query fails the query intent validation rule;
allowing the first query based on a response from the first LLM indicating the first query has a valid intent;
based on detecting a first response to the first query,
prompting the first LLM or another LLM to determine topical coherence and continuity of a conversation corresponding to the first query and the first response, wherein prompting the first LLM or another LLM comprises prompting the first LLM or another LLM to at least identify topics in the conversation, to determine coherence of the first response with respect to the conversation, and to determine relevance of each identified topic with respect to the conversation; and
blocking or allowing the first response based on, at least one of, quantity of identified topics, relevance of each topic, and coherence of the first response.

2. The method of claim 1 further comprising determining that the first query does not include one or more keywords corresponding to invalid intent before prompting the first LLM to evaluate the first query against the query intent validation rule.

3. The method of claim 1, wherein the query intent validation rule further comprises an intent description for each valid intent.

4. The method of claim 1, wherein the set of one or more valid intents is based on at least one of a description of the RAG based LLM, the application that uses the RAG based LLM, description of each knowledge base, and historic traffic to the RAG based LLM or application that uses the RAG based LLM.

5. The method of claim 1, wherein prompting to determine topical coherence and continuity comprises prompting to score relevance of each identified topic and to score coherence of the first response with respect to the conversation, wherein blocking or allowing the first response comprises blocking or allowing the first response based on at least one of the coherence score and the topic relevance scores.

6. The method of claim 5, wherein prompting to determine continuity further comprises prompting to determine topical alignment based on the topic relevance scores.

7. The method of claim 6, wherein blocking or allowing the first response comprises blocking the first response if the coherence score does not satisfy a coherence criterion or if the topical relevance scores indicate lack of topical alignment.

8. The method of claim 1, wherein blocking or allowing the first response based on quantity of identified topics comprises blocking the first response if the quantity of identified topics exceeds a coherence threshold for the conversation.

9. A non-transitory machine-readable medium having program code stored thereon, the program code comprising instructions to:
prompt a first large language model (LLM) to evaluate a first query against a query intent validation rule, wherein the instructions to prompt the first LLM comprise instructions to prompt the first LLM with the first query and the query intent validation rule;
reject or allow the first query based on a response from the first LLM indicating whether the first query fails the query intent validation rule or the first query has a valid intent;
based on detecting a first response to an allowed query,
prompt the first LLM or another LLM to determine topical coherence and continuity of a conversation corresponding to the allowed query and the first response, wherein the instructions to prompt the first LLM or another LLM comprise instructions to prompt the first LLM or another LLM to at least identify topics in the conversation, determine coherence of the first response with respect to the conversation, and determine relevance of each identified topic with respect to the conversation; and
block or allow the first response based on, at least one of, quantity of identified topics, relevance of each topic, and coherence of the first response.

10. The non-transitory machine-readable medium of claim 9, wherein the program code further comprises instructions to determine whether the first query includes one or more keywords corresponding to invalid intent before prompting the first LLM to evaluate the first query against the query intent validation rule.

11. The non-transitory machine-readable medium of claim 9, wherein the instructions to prompt the first LLM to evaluate the first query comprise instructions to generate a prompt that includes at least one of a set of one or more valid intents corresponding to a set of one or more knowledge bases and an intent description for each valid intent, wherein the first query is to a retrieval augmented generation (RAG) based LLM or application that uses the RAG based LLM.

12. The non-transitory machine-readable medium of claim 11, wherein the set of one or more valid intents is based on at least one of a description of the RAG based LLM, the application that uses the RAG based LLM, description of each knowledge base, and historic traffic to the RAG based LLM or to an application that uses the RAG based LLM.

13. The non-transitory machine-readable medium of claim 9, wherein the instructions to prompt the first LLM or another LLM to determine topical coherence and continuity comprise instructions to prompt to score relevance of each identified topic and to score coherence of the first response with respect to the conversation, wherein the instructions to block or allow the first response comprise instructions to block or allow the first response based on at least one of the coherence score and the topic relevance scores.

14. The non-transitory machine-readable medium of claim 13, wherein the instructions to prompt to determine continuity further comprise instructions to prompt to determine topical alignment based on the topic relevance scores.

15. The non-transitory machine-readable medium of claim 14, wherein the instructions to block or allow the first response comprise instructions to block the first response if the coherence score does not satisfy a coherence criterion or if the topical relevance scores indicate lack of topical alignment.

16. The non-transitory machine-readable medium of claim 9, wherein the instructions to block or allow the first response based on quantity of identified topics comprise instructions to block the first response if the quantity of identified topics exceeds a coherence threshold for the conversation.

17. An apparatus comprising:
a processor; and
a machine-readable medium having stored thereon instructions executable by the processor to cause the apparatus to,
prompt a first large language model (LLM) to evaluate a first query against a query intent validation rule, wherein the instructions to prompt the first LLM comprise instructions to prompt the first LLM with the first query and the query intent validation rule;
reject or allow the first query based on a response from the first LLM indicating whether the first query fails the query intent validation rule or the first query has a valid intent;
based on detecting a first response to an allowed query,
prompt the first LLM or another LLM to determine topical coherence and continuity of a conversation corresponding to the allowed query and the first response, wherein the instructions to prompt the first LLM or another LLM comprise instructions to prompt the first LLM or another LLM to at least identify topics in the conversation, determine coherence of the first response with respect to the conversation, and determine relevance of each identified topic with respect to the conversation; and
block or allow the first response based on, at least one of, quantity of identified topics, relevance of each topic, and coherence of the first response.

18. The apparatus of claim 17, wherein the instructions to prompt the first LLM to evaluate the first query comprise instructions executable by the processor to cause the apparatus to generate a prompt that includes at least one of a set of one or more valid intents corresponding to a set of one or more knowledge bases and an intent description for each valid intent, wherein the first query is to a retrieval augmented generation (RAG) based LLM or application that uses the RAG based LLM.

19. The apparatus of claim 18, wherein the set of one or more valid intents is based on at least one of a description of the RAG based LLM, the application that uses the RAG based LLM, description of each knowledge base, and historic traffic to the RAG based LLM or to an application that uses the RAG based LLM.

20. The apparatus of claim 17, wherein the instructions to prompt the first LLM or another LLM to determine topical coherence and continuity comprise instructions executable by the processor to cause the apparatus to prompt to score relevance of each identified topic and to score coherence of the first response with respect to the conversation, wherein the instructions to block or allow the first response comprise instructions to block or allow the first response based on at least one of the coherence score and the topic relevance scores.
